(19) United States
(12) Patent Application Publication
(10) Pub. No.: US 2019/0144680 A1
(43) Pub. Date: May 16, 2019

(54) SURFACE-TREATED CARBON BLACK, AND METHOD FOR PRODUCING THE SAME

(71) Applicant: TOYO TIRE & RUBBER CO., LTD., Itami-shi (JP)

(72) Inventor: Tsunetaka Mukai, Itami-shi (JP)

(73) Assignee: TOYO TIRE & RUBBER CO., LTD., Itami-shi (JP)

(21) Appl. No.: 16/184,183

(22) Filed: Nov. 8, 2018

(30) Foreign Application Priority Data
Nov. 13, 2017 (JP) 2017-217872

(51) Int. Cl. C09C 1/56; C08K 9/04; C08K 3/04; B60C 1/00

(52) U.S. Cl. CPC C09C 1/56; B60C 1/00; C08K 3/04; C08K 9/04

(57) ABSTRACT

Disclosed is a surface-treated carbon black in which a surface of a carbon black is treated with a compound represented by general formula (I):

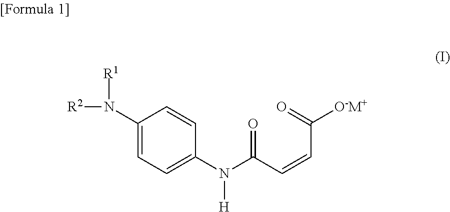

wherein R¹ and R² each represent a hydrogen atom, or an alkyl group, alkenyl group or alkynyl group having 1 to 20 carbon atoms, and R¹ and R² may be the same as or different from each other; and M⁺ represents a sodium ion, potassium ion or lithium ion. The use of this surface-treated carbon black allows to yield a vulcanized rubber low in exothermicity.

### BACKGROUND OF THE INVENTION

### Field of the Invention

The present invention relates to a surface-treated carbon black, and a method for producing the carbon black.

### Description of the Related Art

In order to improve a low fuel consumption property, a low exothermicity and other properties of a pneumatic tire obtained using a rubber composition as raw material, it is known in the prior art (Patent Documents 1 and 2) to use a surface-treated carbon black good in dispersibility in the rubber composition. In Patent Document 1, as a compound for treating a surface of a carbon black, the following is used: an amphoteric compound having, in a single molecule thereof, an acidic functional group and a basic functional group. In Patent Document 2, a diamine compound is used.

In order to improve a carbon black in dispersibility in a rubber composition, it is also known to use a specific compound having, at terminals thereof, a nitrogen functional group and a carbon-carbon double bond (Patent Document 3).

### PRIOR ART DOCUMENTS

### Patent Documents

Patent Document 1: JP-A-2013-241483

Patent Document 2: JP-A-2012-241160

Patent Document 3: JP-A-2014-95013

### SUMMARY OF THE INVENTION

Apart from the above, in the market, as tires (vulcanized rubbers) yielded using a rubber composition as a raw material, tires lower in exothermicity are desired. However, about vulcanized rubbers yielded, respectively, from rubber compositions as described in the above-mentioned patent documents, there remains a room for improving the property described herein.

In the light of the above-mentioned situation, the present invention has been made. An object thereof is to provide a surface-treated carbon black through which a vulcanized rubber low in exothermicity can be yielded, and a method for producing the carbon black.

The present invention relates to a surface-treated carbon black in which a surface of a carbon black is treated with a compound represented by the following general formula (I):

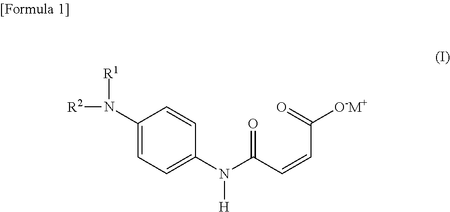

wherein R¹ and R² each represent a hydrogen atom, or an alkyl group, alkenyl group or alkynyl group having 1 to 20 carbon atoms, and R¹ and R² may be the same as or different from each other; and M⁺ represents a sodium ion, potassium ion or lithium ion.

The present invention also relates to a method for producing a surface-treated carbon black that is the above-defined surface-treated carbon black, this method including the step of treating the surface of the carbon black with the compound represented by the general formula (I).

Details of the action mechanism of advantageous effects of the surface-treated carbon black according to the present invention are partially unclear; however, the mechanism is presumed as described below. However, the invention may not be interpreted with any limitation based on this action mechanism.

About the surface-treated carbon black of the present invention, a surface of its carbon black is treated with a compound represented by the general formula (I). It is presumed that by treating the carbon black surface with the compound represented by the general formula (I), this compound, represented by the general formula (I), can adhere (or be bound) effectively to the carbon black surface (functional groups (for example, carboxyl groups) present on the surface, the number of these groups being small). It is presumed that, in particular, in the case of using an aqueous solution containing the compound represented by the general formula (I), the carbon black and the compound represented by the general formula (I) are raised in contact efficiency therebetween, so that the compound represented by the general formula (I) can adhere (or be bound) more effectively to the surface.

It is presumed that the use of this surface-treated carbon black, as a raw material of a rubber composition for tires, allows that carbon-carbon double bond moieties of the compound, represented by the general formula (I), which are present in the surface-treated carbon black are bound to the rubber component (polymer) by reaction with radicals of the rubber component (polymer) or reaction associated with sulfur crosslinkage. Thus, the resultant vulcanized rubber is excellent in low exothermicity.

### DETAILED DESCRIPTION OF THE PREFERRED EMBODIMENTS

### <Surface-Treated Carbon Black>

The surface-treated carbon black of the present invention is a surface-treated carbon black in which a surface of a carbon black is treated with a compound represented by the following general formula (I):

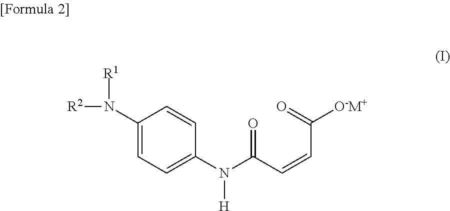

wherein R¹ and R² each represent a hydrogen atom, or an alkyl group, alkenyl group or alkynyl group having 1 to 20 carbon atoms, and R¹ and R² may be the same as or different from each other; and M⁺ represents a sodium ion, potassium ion or lithium ion.

The carbon black is any carbon black used in an ordinary rubbery industry, such as SAF, ISAF, HAF, FEF, or GPF. The carbon black may be an electroconductive carbon black such as acetylene black or Ketchen black. The carbon black may be any granulated carbon black, which has been granulated, considering the handleability of the carbon black in an ordinary rubbery industry; or a non-granulated carbon black. Such carbon blacks may be used singly or in any combination of two or more thereof.

About the carbon black, from the viewpoint of an improvement thereof in vulcanized-rubber-reinforcing performance, the DBP absorption (dibutyl phthalate absorption) thereof is preferably 80 cm³/100-g or more, more preferably 110 cm³/100-g or more, and is preferably 180 cm³/100-g or less, more preferably 140 cm³/100-g or less.

About the carbon black, from the viewpoint of an improvement of the resultant vulcanized rubber in low exothermicity, the nitrogen adsorption specific area is preferably 30 m²/g or more, more preferably 50 m²/g or more, even more preferably 80 m²/g or more, and is preferably 250 m²/g or less, more preferably 200 m²/g or less, even more preferably 150 m²/g or less, even more preferably 120 m²/g or less.

The compound represented by the general formula (I) is preferably a compound about which R¹ and R² in the general formula (I) are each a hydrogen atom, and M⁺ is a sodium ion, that is, a compound represented by the following general formula (I′):

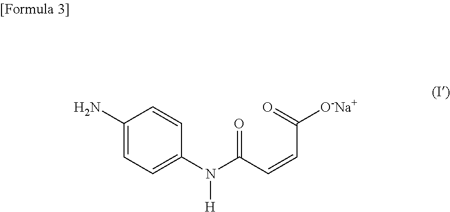

from the viewpoint of an improvement of the compound in affinity with the carbon black.

The compound represented by the general formula (I) is preferably used in the form of an aqueous solution containing the compound represented by the general formula (I) from the viewpoint of an improvement of the compound in efficiency of contacting the carbon black. A medium in the aqueous solution is a medium made of water as a main component, such as ion exchange water, distilled water or industrial water. The medium may be, for example, water containing an organic solvent. Such media may be used singly or in any combination of two or more thereof.

The proportion of the compound represented by the general formula (I) in the aqueous solution containing the compound represented by the general formula (I) is preferably 0.1% or more, more preferably 0.3% or more, even more preferably 0.5% or more, even more preferably 1.5% or more by weight from the viewpoint of an improvement of the resultant vulcanized rubber in low exothermicity. The proportion is preferably 80% or less, more preferably 75% or less, even more preferably 50% or less, even more preferably 30% or less by weight from the viewpoint of a sufficient dissolution of the compound represented by the general formula (I) in the medium.

In the surface-treated carbon black, the use amount (surface treating amount) of the compound represented by the general formula (I) is preferably from 0.1 to 30 parts by weight, more preferably from 0.25 to 10 parts by weight, even more preferably from 0.5 to 5.0 parts by weight, even more preferably from 0.5 to 3.0 parts by weight for 100 parts by weight of the carbon black.

### <Production Method of a Surface-Treated Carbon Black>

In the method for producing a surface-treated carbon black, a manner for the surface treatment is not particularly limited. The manner is, for example, the following manner while a carbon black is stirred (or caused to flow) in, for example, a mixer or blender: a manner 1) of adding, thereto, the compound represented by the general formula (I) or an aqueous solution containing this compound to conduct stirring treatment; a manner 2) of using a spraying device such as a spray to conduct spraying treatment with an aqueous solution containing the compound represented by the general formula (I); or a manner 3) of adding the compound represented by the general formula (I) to water used in the step of granulating a carbon black, so as to treat the carbon black. The manner for the surface treatment is preferably the spraying manner from the viewpoint of a uniform painting of the aqueous solution.

In the surface treatment, the treating temperature is preferably from about 10 to 50° C., more preferably from about 20 to 30° C. The treating period is not mentioned without reservation since the period depends on the amount of the used carbon black. The period is usually from about 3.0 to 5.0 minutes.

A surface-treated carbon black yielded by the surface treatment is usable without undergoing any drying step such as a natural drying step or a forcible drying step to make the mixing period short. However, after the surface treatment step the surface-treated carbon black may undergo such a drying step.

### <Rubber Composition>

In the present invention, a rubber composition can be prepared by using the above-defined surface-treated carbon black. Raw Materials of the rubber composition are a rubber and various blending agents that are usually used in the rubbery industry.

Examples of the rubber include natural rubber (NR); and synthetic diene rubbers such as isoprene rubber (IR), styrene-butadiene rubber (SBR), butadiene rubber (BR), chloroprene rubber (CR), and nitrile rubber (NBR). Such rubbers may be used singly or in any combination of two or more thereof.

The amount of the compound represented by the general formula (I) is preferably from 0.01 to 10 parts by weight, more preferably from 0.1 to 5.0 parts by weight, even more preferably 0.5 to 2.0 parts by weight for 100 parts by weight of the rubber component in the rubber composition from the viewpoint of an improvement of the vulcanized rubber in low exothermicity.

The surface-treated carbon black is preferably from 30 to 100 parts by weight, more preferably from 35 to 80 parts by weight, even more preferably from 40 to 70 parts by weight for 100 parts by weight of the rubber component in the rubber composition from the viewpoint of an improvement of the vulcanized rubber in reinforceability.

Examples of the various blending agents include sulfur-based vulcanizers, vulcanization promoters, antiaging agents, silica, silane coupling agents, zinc oxide, methylene receptors and methylene donors, stearic acid, vulcanization promotion aids, vulcanization retarders, organic oxides, softeners such as wax and oil, and processing aids.

The species of sulfur for the sulfur-based vulcanizers may be any sulfur species for ordinary rubbers. Examples of the species include powdery sulfur, precipitated sulfur, insoluble sulfur, and highly dispersed sulfur. The sulfur-based vulcanizers may be used singly or in any combination of two or more thereof.

The content of the sulfur species is preferably from 0.3 to 6.5 parts by weight for 100 parts by weight of the rubber component in the rubber composition. If the content of the sulfur species is less than 0.3 parts by weight, the vulcanized rubber is short in crosslinkage density to be lowered in strength and others. If the content is more than 6.5 parts by weight, the vulcanized rubber is deteriorated, in particular, in both of heat resistance and endurance. The content of the sulfur species is more preferably from 1.0 to 5.5 parts by weight for 100 parts by weight of the rubber component in the rubber composition to cause the vulcanized rubber to keep a good rubber strength and have better heat resistance and endurance.

The vulcanization promoters may each be any vulcanization promoter for ordinary rubbers. Examples thereof include sulfenamide based, thiuram based, thiazole based, thiourea based, guanidine based and dithiocarbamic acid salt based vulcanization promoters. The vulcanization promoters may be used singly or in any combination of two or more thereof.

The content of the vulcanization promoter(s) is preferably from 1 to 5 parts by weight for 100 parts by weight of the rubber component in the rubber composition.

The antiaging agents may each be any antiaging agent for ordinary rubbers. Examples thereof include aromatic amine based, amine-ketone based, monophenol based, bisphenol based, polyphenol based, dithiocarbamic acid salt based, and thiourea based antiaging agents. The antiaging agents may be used singly or in any combination of two or more thereof.

The content of the antiaging agent(s) is preferably from 1 to 5 parts by weight for 100 parts by weight of the rubber component in the rubber composition.

The method for blending (or adding) the surface-treated carbon black, the rubber, and the various blending agents into each other is, for example, a method of kneading these component using a kneading machine used in an ordinary rubber industry, such as a Banbury mixer, a kneader, or a roll.

The kneading method is not particularly limited, and is, for example, a method of adding components other than vulcanization-related components, such any sulfur based vulcanizer and any vulcanization promotion aid, to each other in any order or adding these components to each other simultaneously, so as to knead these components, or adding all the components to each other simultaneously to knead the components. The number of times of the kneading may be one or plural. The period for the kneading is varied in accordance with the size of a kneading machine used for the kneading, and some other factor. It is advisable to set the period usually into the range of about 2 to 5 minutes. The discharging-temperature of the rubber composition in the kneading machine is set to a range preferably from 120 to 170° C., more preferably from 120 to 150° C. When the rubber composition includes one or more of the vulcanization related components, the discharging-temperature in the kneading machine is set to a range preferably from 80 to 110° C., more preferably from 80 to 100° C.

A vulcanized rubber yielded from the rubber composition including the surface-treated carbon black of the present invention is low in exothermicity to be suitable for pneumatic tires.

### EXAMPLES

Hereinafter, the present invention will be described by way of working examples thereof. However, the invention is never limited by these working examples.

### (Used Raw Materials)

a) Compound represented by the general formula (I′): sodium (2Z)-4-[(4-aminophenyl)amino]-4-oxo-2-butanoate “SUMILINK 200” (manufactured by Sumitomo Chemical Co., Ltd.)

b) Carbon black: “SEAST6 (N220)” (nitrogen adsorption specific surface area: 119 m²/g, and DBP absorption: 114 cm³/100-g (manufactured by Tokai Carbon Co., Ltd.)

c) Natural rubber: “RSS#3”

d) Zinc oxide: “ZINC OXIDE Grade 2” (manufactured by Mitsui Mining & Smelting Co., Ltd.)

e) Stearic acid: “BEADS STEARIC ACID” (manufactured by NOF Corp.)

f) Sulfur: “5%-OIL-INCORPORATED FINELY-POWDERY SULFUR” (manufactured by Tsurumi Chemical Industry Co., Ltd.)

g) Vulcanization promoter (A): N-cyclohexyl-2-benzothiazole sulfenamide: “SANCELER CM-G” (manufactured by Sanshin Chemical Industry Co., Ltd.)

h) Vulcanization promoter (B): N-tert-butyl-2-benzothiazolylsulfenamide: “NOCCELLAR NS-P” (manufactured by Ouchi Shinko Chemical Industrial Co., Ltd.)

### Example 1

### <Production of a Surface-Treated Carbon Black 1>

A compound represented by the general formula (I′) (trade name: “SUMILINK 200”) was measured out for a predetermined amount of a carbon black to set the ratio by weight of the carbon black to the compound the general formula (I) to a ratio by weight that is shown in Table 1. Distilled water was added to the whole amount of the measured-out compound represented by the general formula (I) to set the concentration of the compound represented by the general formula (I′) to 0.5% by weight of the whole amount. A spray gun was used to spray the resultant aqueous solution containing (0.5% by weight of) the compound represented by the general formula (I′) onto the above-mentioned predetermined amount of the carbon black at a temperature of 23° C. while a mixture (“SMV-20”, manufactured by KAWATA MFG Co., Ltd.) was used to stir this mixture system. The blend proportion of any component in Table 1 is represented by the numerical value (phr) of the part(s) by weight of this component when the whole amount of a rubber component contained in the corresponding rubber composition shown in Table 2 is regarded as 100 parts by weight.

### <Production of a Rubber Composition and an Unvulcanized Rubber Composition>

A Banbury mixer was used to dry-mix the surface-treated carbon black 1 yielded as described above with individual materials (i.e., components other than sulfur and any vulcanization promoter) shown in Table 2 (kneading period: 3 minutes; composition-discharging temperature: 150° C.). In this way, a rubber composition was produced. Next, to the resultant rubber composition were added sulfur, a vulcanization promoter (A) and a vulcanization promoter (B) that are shown in Table 2, and then the Banbury mixer was used to dry-mix all the components (kneading period: 1 minute; component-discharging-temperature: 90° C.). In this way, an unvulcanized rubber composition was produced. The blend proportion of any component in Table 2 is represented by the numerical value (phr) of the part(s) by weight of this component when the whole amount of the rubber component contained in the corresponding rubber composition is regarded as 100 parts by weight. The numerical value of the part(s) by weight of any surface-treated carbon black in Table 2 represents only the numerical value of the total weight of the carbon black and the compound represented by the general formula (I′).

### Examples 2 and 3

### <Production of Surface-Treated Carbon Blacks>

Surface-treated carbon blacks 2 and 3 were each produced by the same operations as in Example 1 except that in the aqueous solution containing the compound represented by the general formula (I′), the concentration of this compound was changed as shown in Table 1.

### <Production of Rubber Compositions and Unvulcanized Rubber Compositions>

In each of the examples, a rubber composition and an unvulcanized rubber composition were produced in the same way as in Example 1 except that the species of the surface-treated carbon black were changed as shown in Table 2.

### Comparative Examples 1 and 2

In each of the examples, a Banbury mixer was used to dry-mix individual raw materials (i.e., components other than sulfur and any vulcanization promoter) shown in Table 2 (kneading period: 3 minutes; composition-discharging-temperature: 150° C.). In this way, a rubber composition was produced. Next, to the resultant rubber composition were added sulfur, a vulcanization promoter (A) (and a vulcanization promoter (B)) that are shown in Table 2, and then a Banbury mixer was used to dry-mix these components (kneading period: 1 minute; composition-discharging-temperature: 90° C.). In this way, an unvulcanized rubber composition was produced.

The unvulcanized rubber composition yielded in each of the working examples and the comparative examples was vulcanized at 150° C. for 30 minutes to produce a vulcanized rubber. The resultant vulcanized rubber was evaluated as described below. The evaluation results are shown in Table 2.

### <Exothermicity Evaluation>

About the evaluation of the exothermicity of each of the examples, a viscoelasticity measuring instrument manufactured by Toyo Seiki Kogyo Co., Ltd. was used to measure the loss coefficient tan δ under conditions that a static strain of 10%, a dynamic strain of ±2%, a frequency of 50 Hz, and a temperature of 60° C. The loss coefficient in each of Examples was represented by an index relative to the value thereof in Comparative Example 1 which was regarded as 100. As the index of the vulcanized rubbers is smaller, the vulcanized rubbers less easily generate heat. This matter means that the vulcanized rubbers are better in low exothermicity.

TABLE 1

| | Surface- | Surface- | Surface- |
|---|---|---|---|
| | treated carbon | treated carbon | treated carbon |
| | black 1 | black 2 | black 3 |
| Carbon black | 50 | 50 | 50 |
| Compound represented | 1 | 1 | 1 |
| by general formula | | | |
| (I′) | | | |
| Aqueous solution | 0.5 | 30 | 75 |
| concentration | | | |
| (% by weight) | | | |

TABLE 2

| | Comparative | Comparative | | | |
|---|---|---|---|---|---|
| | Example 1 | Example 2 | Example 1 | Example 2 | Example 3 |
| Natural rubber | 100 | 100 | 100 | 100 | 100 |
| Carbon black | 50 | 50 | | | |
| Surface-treated | | | 51 | | |
| carbon black 1 | | | | | |
| Surface-treated | | | | 51 | |
| carbon black 2 | | | | | |
| Surface-treated | | | | | 51 |
| carbon black 3 | | | | | |
| Compound represented by | | 1 | | | |
| general formula (I′) | | | | | |
| Zinc oxide | 3 | 3 | 3 | 3 | 3 |
| Stearic acid | 2 | 2 | 2 | 2 | 2 |
| Sulfur | 2 | 2 | 2 | 2 | 2 |
| Vulcanization promoter | 1.5 | 1.5 | 1.5 | 1.5 | 1.5 |
| (A) | | | | | |
| Vulcanization promoter | 0.5 | 0.5 | 0.5 | 0.5 | 0.5 |
| (B) | | | | | |
| Exothermicity | 100 | 95 | 90 | 81 | 85 |

What is claimed is:

1. A surface-treated carbon black in which a surface of a carbon black is treated with a compound represented by general formula (I): 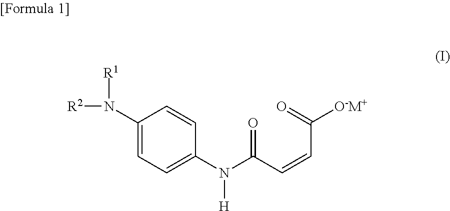
wherein R¹ and R² each represent a hydrogen atom, or an alkyl group, alkenyl group or alkynyl group having 1 to 20 carbon atoms, and R¹ and R² may be the same as or different from each other; and M⁺ represents a sodium ion, potassium ion or lithium ion.

2. The surface-treated carbon black according to claim 1, which is treated with an aqueous solution containing the compound represented by the general formula (I).

3. The surface-treated carbon black according to claim 2, wherein a proportion of the compound represented by the general formula (I) in the aqueous solution containing the compound represented by the general formula (I) is from 0.1 to 80% by weight.

4. A method for producing a surface-treated carbon black that is the surface-treated carbon black recited in claim 1,
comprising a step of treating a surface of the carbon black with the compound represented by the general formula (I).

5. The method for producing the surface-treated carbon black according to claim 4, wherein the step of treating the surface with the compound represented by the general formula (I) is a step of treating the surface with an aqueous solution containing the compound represented by the general formula (I).

6. The method for producing the surface-treated carbon black according to claim 5, wherein the surface treating step is a step of conducting spray treatment.
